(19) United States
(12) Patent Application Publication
(10) Pub. No.: US 2025/0102287 A1
(43) Pub. Date: Mar. 27, 2025

(54) INDUCTIVE 360-DEGREE ANGLE SENSOR USING A RADIALLY-SEPARATED DUAL TARGET

(71) Applicant: Allegro MicroSystems, LLC, Manchester, NH (US)

(72) Inventors: Emanuele Andrea Casu, Annecy (FR); Ross Eisenbeis, Litchfield, NH (US)

(73) Assignee: Allegro MicroSystems, LLC, Manchester, NH (US)

(21) Appl. No.: 18/475,674

(22) Filed: Sep. 27, 2023

(51) Int. Cl. G01B 7/30

(52) U.S. Cl. CPC G01B 7/30

(57) ABSTRACT

A method, comprising: providing a target including: (i) a base having a through-hole formed therein that defines an inner perimeter of the base, the base having an outer side running around an outer perimeter of the base, and the base having an inner side running around the inner perimeter of the base, (ii) a first set of first conductive features that are coupled to the outer side of the base, each of the first conductive features extending outwardly, (iii) and a second set of second conductive features that are coupled to the inner side of the base, each of the second conductive features extending inwardly; and detecting an angular position of the target based on a first electrical angle that is associated with the first set of first conductive features and a second electrical angle that is associated with the second set of second conductive features.

### BACKGROUND

As is known, sensors are used to perform various functions in a variety of applications. Some sensors include one or more electromagnetic flux sensing elements, such as a Hall effect element, a magnetoresistive element, or a receiving coil to sense an electromagnetic flux associated with proximity or motion of a target object. Sensor integrated circuits are widely used in automobile control systems and other safety-critical applications. There are a variety of specifications that set forth requirements related to permissible sensor quality levels, failure rates, and overall functional safety.

### SUMMARY

According to aspects of the disclosure, a method is provided, comprising: providing a target including: (i) a base having a through-hole formed therein that defines an inner perimeter of the base, the base having an outer side running around an outer perimeter of the base, and the base having an inner side running around the inner perimeter of the base, (ii) a first set of first conductive features that are coupled to the outer side of the base, each of the first conductive features extending outwardly, (iii) and a second set of second conductive features that are coupled to the inner side of the base, each of the second conductive features extending inwardly, wherein a first count of the first conductive features in the first set is different from a second count of the second conductive features in the second set; and detecting an angular position of the target based on a first electrical angle that is associated with the first set of first conductive features and a second electrical angle that is associated with the second set of second conductive features, wherein the angular position of the target is in the range 0-360 mechanical degrees so that the detected angular position covers an entire mechanical revolution of the target.

According to aspects of the disclosure, a target for use in inductive sensing applications, the target comprising: a substrate; a first set of first conductive features that are formed on the substrate, each of the first conductive features being aligned with a first loop; and a second set of second conductive features that are formed on the substrate, each of the second conductive features being aligned with a second loop, the second loop being nested inside the first loop, wherein a first count of the first conductive features in the first set is different from a second count of the second conductive features in the second set.

According to aspects of the disclosure, a system is provided comprising: a target including: (i) a base having a through-hole formed therein that defines an inner perimeter of the base, the base having an outer side running around an outer perimeter of the base, and the base having an inner side running around the inner perimeter of the base, (ii) a first set of first conductive features that are coupled to the outer side of the base, each of the first conductive features extending outwardly, and (iii) a second set of second conductive features that are coupled to the inner side of the base, each of the second conductive features extending inwardly, wherein a first count of the first conductive features in the first set is different from a second count of the second conductive features in the second set; a first receiving coil configured to generate a first signal in response to a first reflected magnetic field that is produced by the first set of conductive features; a second receiving coil configured to generate a second signal in response to the first reflected magnetic field that is produced by the first set of conductive features; a third receiving coil configured to generate a third signal in response to a second reflected magnetic field that is produced by the second set of conductive features; a fourth receiving coil configured to generate a fourth signal in response to the second reflected magnetic field that is produced by the first set of conductive features; and a processing circuitry that is configured to generate an output signal based, at least in part, on the first signal, the second signal, the third signal, and the fourth signal, the output signal being indicative of an angular position of the target.

### BRIEF DESCRIPTION OF THE DRAWINGS

The foregoing features may be more fully understood from the following description of the drawings in which:

FIG. 1 is a diagram of an example of a system, according to aspects of the disclosure;

FIG. 2 is a diagram of an example of a sensor, according to aspects of the disclosure;

FIG. 3A is a diagram of an example of a receiving coil, according to aspects of the disclosure;

FIG. 3B is a diagram of an example of a receiving coil, according to aspects of the disclosure;

FIG. 4 is a diagram of an example of a set of transmitting coils, according to aspects of the disclosure;

FIG. 5 is a diagram of an example of a target, according to aspects of the disclosure;

FIG. 6 is a diagram of an example of a target, according to aspects of the disclosure;

FIG. 7A is a diagram of an example of a target feature, according to aspects of the disclosure;

FIG. 7B is a diagram of an example of a target feature, according to aspects of the disclosure;

FIG. 8A is a schematic cross-sectional view of an assembly utilizing the target of FIG. 5, according to aspects of the disclosure;

FIG. 8B is a schematic cross-sectional view of an assembly utilizing the target of FIG. 6, according to aspects of the disclosure;

FIG. 8C is a schematic cross-sectional view of an assembly utilizing the target of FIG. 5, according to aspects of the disclosure;

FIG. 9A is a top-down view of the assembly of FIG. 8A, according to aspects of the disclosure;

FIG. 9B is a top-down view of the assembly of FIG. 8B, according to aspects of the disclosure; and

FIG. 10 is a diagram of an example of a system, according to aspects of the disclosure.

### DETAILED DESCRIPTION

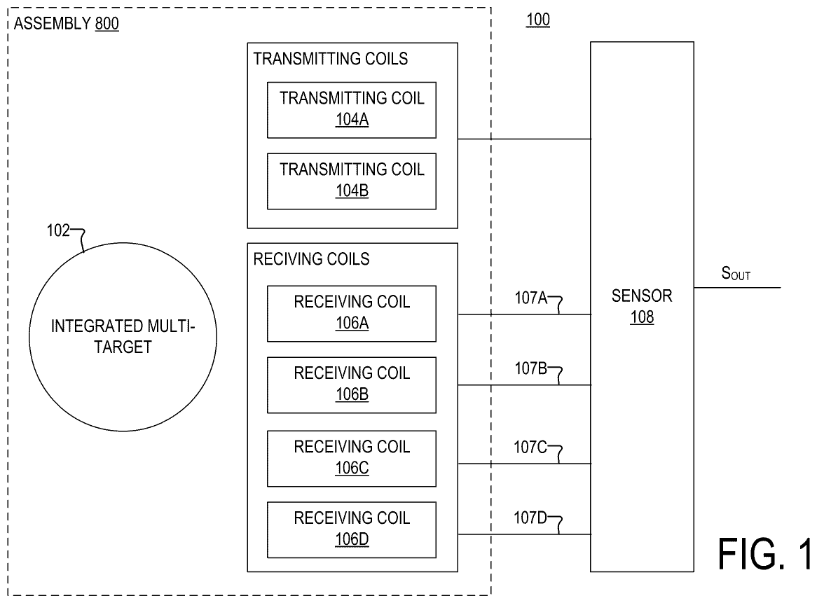

FIG. 1 is a diagram of an example of a system 100, according to aspects of the disclosure. The system 100 may include an integrated multi-target 102 (hereinafter “target 102”), an assembly 800, and an inductive sensor 108. Assembly 800 may include transmitting coils 104A and 104B and receiving coils 106A, 106B, 106C, and 106D.

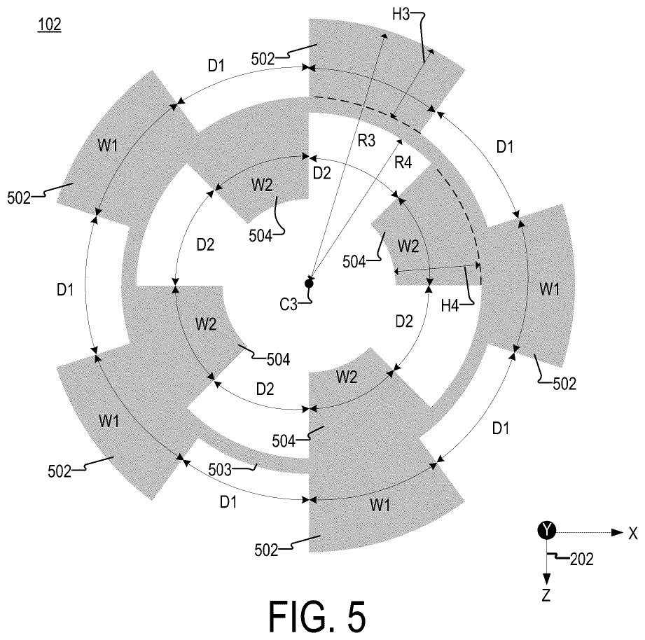

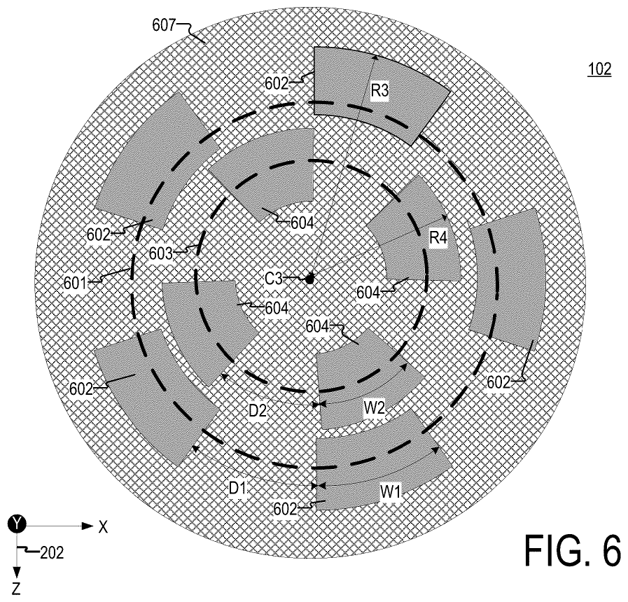

Transmitting coil 104A may generate a first magnetic field. The first magnetic field may induce first eddy currents in a set of outer conductive features of target 102. The first eddy currents may result in a first reflected magnetic field being emitted from the outer set of conductive features of the target 102. Receiving coils 106A and 106B may sense the first reflected field and generate magnetic field signals 107A and 107B in response to the first reflected field. The set of outer features of target 102 may be the same or similar to the set of features 502 and/or the set of features 602, which are discussed further below with respect to FIGS. 5 and 6, respectively. As used herein, the term “magnetic field signal” refers to a voltage signal that is generated, at least in part, by a receiving coil in response to a magnetic field. A magnetic field signal may be a pick-up voltage signal that develops on a receiving coil, which may or may not be subsequently processed to remove error or for another reason.

Transmitting coil 104B may generate a second magnetic field. The second magnetic field may induce second eddy currents in a set of inner features of target 102. The second eddy currents may result in a second reflected magnetic field being emitted from the set of inner features of the target 102. The receiving coils 106C and 106D may sense the second reflected field and generate magnetic field signals 107C and 107D in response to the second reflected field. The set of inner features of target 102 may be the same or similar to the set of features 504 and/or the set of features 604, which are discussed further below with respect to FIGS. 5 and 6, respectively.

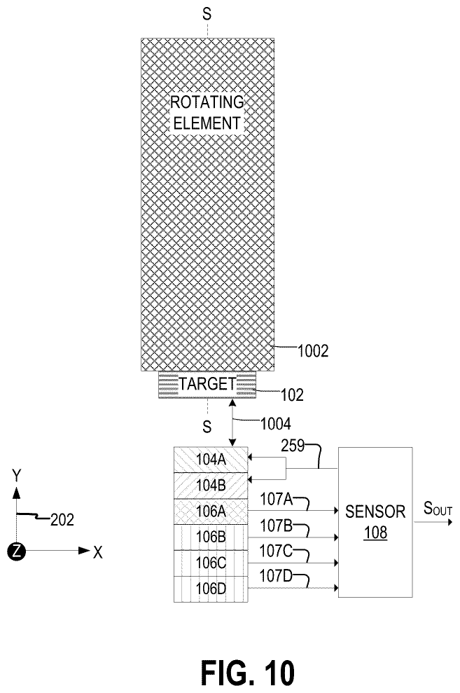

In some implementations, target 102 may be coupled to a shaft or another rotating element (e.g., see FIG. 10) and it may be used to measure the angular position of the shaft or another rotating element. In this regard, sensor 108 may process signals 107A-D to generate a signal Sout, which is indicative of the angular position of target 102 and/or the shaft or other rotating element. An example of a method for generating signal Sout is discussed further below with respect to FIG. 10.

Although system 100 uses two different transmitting coils, wherein each transmitting coil is arranged to excite a different track in target 102, alternative implementations are possible in which one coil is used to excite both tracks (e.g., excite the set of features 502/602 and excite the set of features 504/604, which are shown in FIGS. 5-6, respectively).

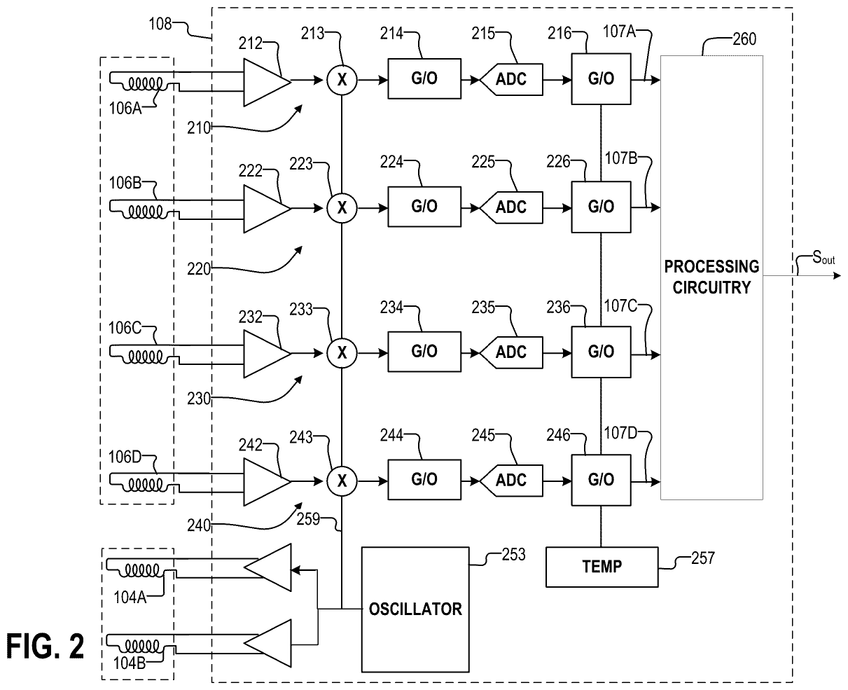

FIG. 2 is a circuit diagram of the sensor 108, according to aspects of the disclosure. As illustrated, the sensor 108 may include signal paths 210, 220, 230, and 240, a processing circuitry 260, a temperature sensor 257, and an oscillator 253. Each of the signal paths 210-240 may be coupled to a different one of the receiving coils 106A-D. Each of the signal paths 210-240 may be configured to generate a respective one of signals 107A-D based on the magnetic field signal that is present on a corresponding one of the receiving coils 106A-D.

The processing circuitry 260 may be configured to receive the signals 107A-D and generate the signal Sout based on the signals 107A-D. The processing circuitry 260 may include any suitable type of electronic circuitry. By way of example, the processing circuitry 260 may include one or more of digital logic, a field-programmable gate array, a CORDIC processor, a general-purpose processor, a special-purpose processor, and/or application-specific processing circuitry.

The oscillator 253 may be configured to drive the transmitting coils with a signal 259. Although in the example of FIG. 2 the oscillator 253 is configured to drive two different transmitting coils, alternative implementations are possible in which the oscillator 253 is configured to drive only one transmitting coil or a different number of transmitting coils.

Signal path 210 may include an amplifier 212, a demodulator 213, a first gain/offset adjustment circuit 214, an analog-to-digital converter (ADC) 215, and a second gain/offset adjustment circuit 216. In operation, receiving coil 106A may generate a magnetic field signal in response to a reflected magnetic field that is produced by the set of outer features of target 102. The receiving coil 106A may provide the magnetic field signal to the amplifier 212. The amplifier 212 may amplify the magnetic field signal and provide the amplified signal to the demodulator 213. The demodulator 213 may demodulate the magnetic field signal, based on the signal 259, and provide the demodulated signal to the first gain/offset adjustment circuit 214. The first gain/offset adjustment circuit 214 may adjust the gain and/or offset of the demodulated signal and provide the adjusted signal to the ADC 215. The ADC 215 may digitize the demodulated signal and provide the digitized signal to the second gain/offset adjustment circuit 216. The second gain/offset adjustment circuit 216 may adjust the gain and/or offset of the digitized signal based on a signal provided by temperature sensor 257 and generate the signal 107A as a result.

Signal path 220 may include an amplifier 222, a demodulator 223, a first gain/offset adjustment circuit 224, an analog-to-digital converter (ADC) 225, and a second gain/offset adjustment circuit 226. In operation, receiving coil 106B may generate a magnetic field signal in response to a reflected magnetic field that is produced by the set of outer features of target 102. The receiving coil 106B may provide the magnetic field signal to the amplifier 222. The amplifier 222 may amplify the magnetic field signal and provide the amplified signal to the demodulator 223. The demodulator 223 may demodulate the magnetic field signal, based on the signal 259, and provide the demodulated signal to the first gain/offset adjustment circuit 224. The first gain/offset adjustment circuit 224 may adjust the gain and/or offset of the demodulated signal and provide the adjusted signal to the ADC 225. The ADC 225 may digitize the demodulated signal and provide the digitized signal to the second gain/offset adjustment circuit 226. The second gain/offset adjustment circuit 226 may adjust the gain and/or offset of the digitized signal based on a signal provided by temperature sensor 257 and generate the signal 107B as a result.

Signal path 230 may include an amplifier 232, a demodulator 233, a first gain/offset adjustment circuit 234, an analog-to-digital converter (ADC) 235, and a second gain/offset adjustment circuit 236. In operation, receiving coil 106C may generate a magnetic field signal in response to a reflected magnetic field that is produced by the set of inner features of target 102. The receiving coil 106C may provide the magnetic field signal to the amplifier 232. The amplifier 232 may amplify the magnetic field signal and provide the amplified signal to the demodulator 233. The demodulator 233 may demodulate the magnetic field signal, based on the signal 259, and provide the demodulated signal to the first gain/offset adjustment circuit 234. The first gain/offset adjustment circuit 234 may adjust the gain and/or offset of the demodulated signal and provide the adjusted signal to the ADC 235. The ADC 235 may digitize the demodulated signal and provide the digitized signal to the second gain/offset adjustment circuit 236. The second gain/offset adjustment circuit 236 may adjust the gain and/or offset of the digitized signal based on a signal provided by temperature sensor 257 and generate the signal 107C as a result.

Signal path 240 may include an amplifier 242, a demodulator 243, a first gain/offset adjustment circuit 244, an analog-to-digital converter (ADC) 245, and a second gain/offset adjustment circuit 246. In operation, receiving coil 106D may generate a magnetic field signal in response to a reflected magnetic field that is produced by the set of inner features of target 102. The receiving coil 106D may provide the magnetic field signal to the amplifier 242. The amplifier 242 may amplify the magnetic field signal and provide the amplified signal to the demodulator 243. The demodulator 243 may demodulate the magnetic field signal, based on the signal 259, and provide the demodulated signal to the first gain/offset adjustment circuit 244. The first gain/offset adjustment circuit 244 may adjust the gain and/or offset of the demodulated signal and provide the adjusted signal to the ADC 245. The ADC 245 may digitize the demodulated signal and provide the digitized signal to the second gain/offset adjustment circuit 246. The second gain/offset adjustment circuit 246 may adjust the gain and/or offset of the digitized signal based on a signal provided by temperature sensor 257 and generate the signal 107D as a result.

The processing circuitry 260 may receive signals 107A-D and generate the signal Sout. As noted above, the signal Sout may be indicative of the angular position of target 102.

FIG. 2 is provided as an example only to illustrate one possible sensor architecture that can be used together with target 102. In this regard, it will be understood that the present disclosure is not limited to sensor 108 having any specific configuration. Although in the example of FIG. 2 each of signal paths 210-240 includes a separate ADC, alternative implementations are possible in which a single time-multiplex ADC is used for all of signal paths. 120.

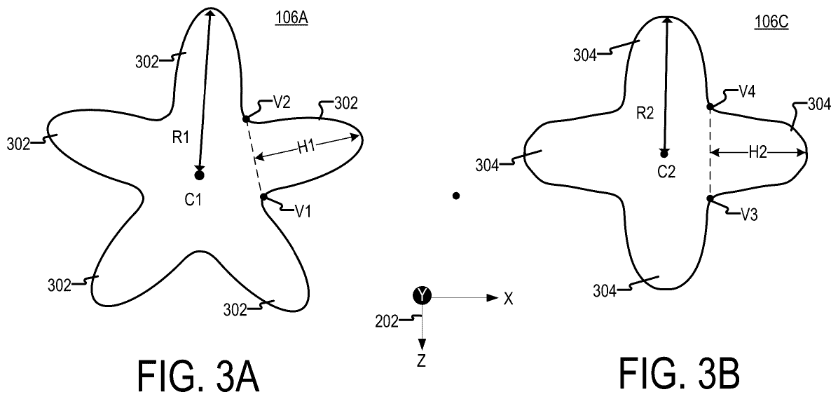

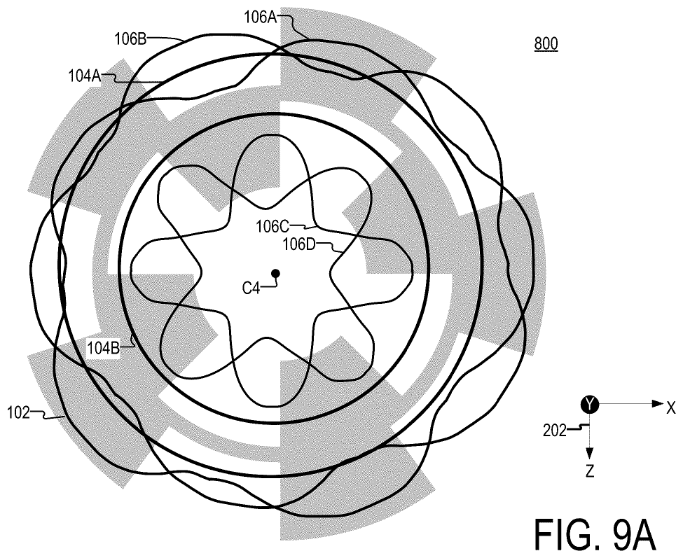

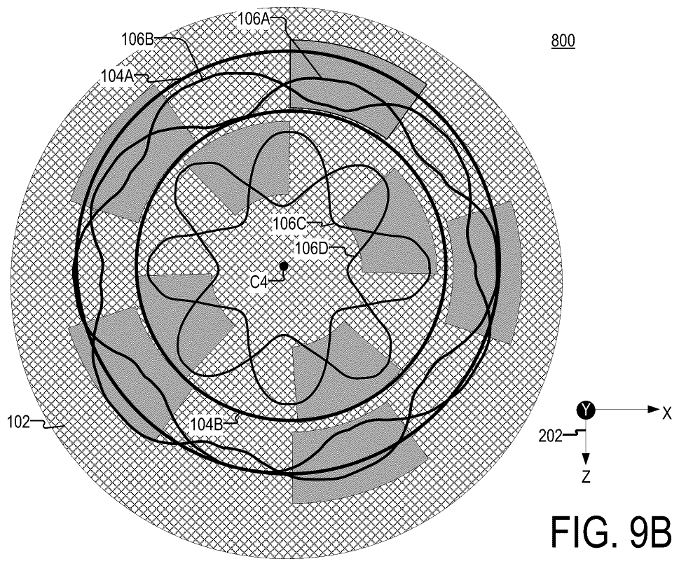

FIG. 3A shows an example of receiving coil 106A, according to aspects of the disclosure. As illustrated, receiving coil 106A may include a plurality of lobes 302 and a radius R1 that extends from the center C1 of receiving coil 106A to the apex of any of lobes 302. In some implementations, each of lobes 302 may have an identical shape and size to any other of the lobes 302. Additionally or alternatively, in some implementations, the shape of receiving coil 106A may be symmetrical with respect to the center C1. In some implementations, receiving coil 106A may have a sinusoidal shape. The sinusoidal shape may be described as a sinewave throughout rotation. Or put differently, the sinusoidal shape may be described as the shape that is defined when a wire shaped as a sinusoidal waveform is bent into a loop. Receiving coil 106B may be identical to receiving coil 106A. However, receiving coil 106B may be rotated relative to receiving coil 106A, as is shown in FIG. 9. It will be understood that the present disclosure is not limited to any specific implementation of receiving coils 106A-B.

FIG. 3B shows an example of receiving coil 106C, according to aspects of the disclosure. As illustrated, receiving coil 106C may include a plurality of lobes 304 and a radius R2 that extends from the center C2 of receiving coil 106C to the apex of any of lobes 304. In some implementations, each of lobes 304 may have an identical shape and size to any other of the lobes 304. Additionally or alternatively, in some implementations, the shape of receiving coil 106C may be symmetrical with respect to the center C2. In some implementations, receiving coil 106C may have a sinusoidal shape. The sinusoidal shape may be described as a sinewave throughout rotation. Or put differently, the sinusoidal shape may be described as the shape that is defined when a wire shaped as a sinusoidal waveform is bent into a loop. Receiving coil 106D may be identical to receiving coil 106C. However, receiving coil 106D may be rotated relative to receiving coil 106C, as is shown in FIG. 9. It will be understood that the present disclosure is not limited to any specific implementation of receiving coils 106C-D.

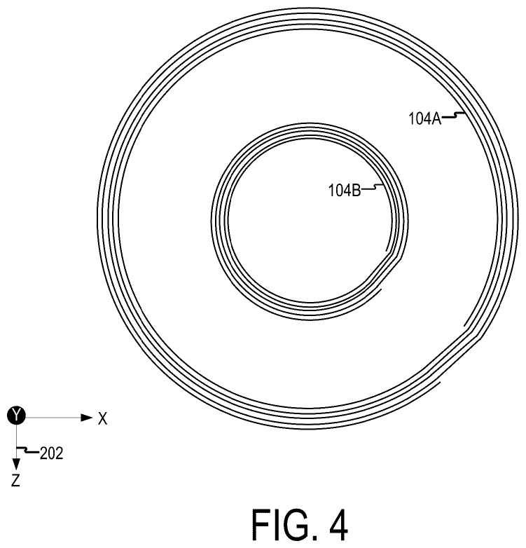

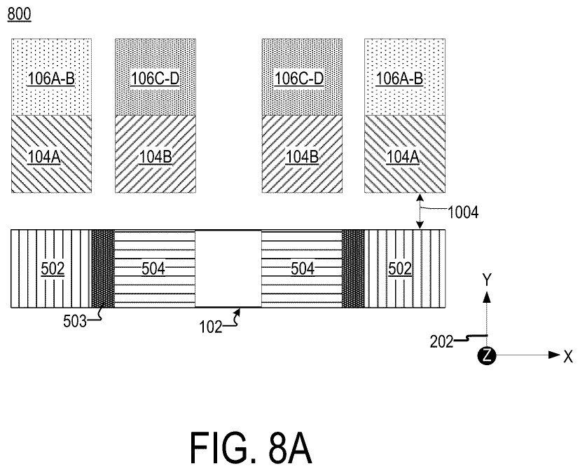

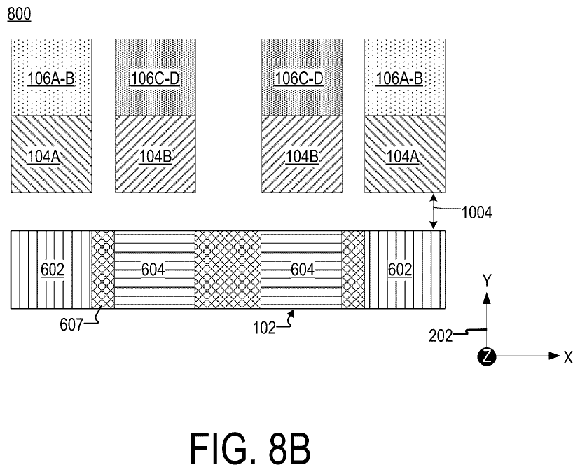

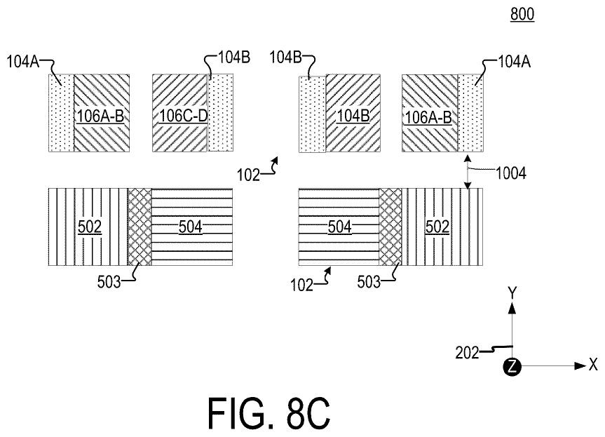

FIG. 4 shows an example of transmitting coils 104A and 104B. As illustrated, each of transmitting coils 104A and 104B may include a conductive loop (e.g., a wire loop or a conductive trace loop including one or more windings). Transmitting coil 104A may be arranged to excite the set of outer features of target 102. Transmitting coil 104B may be arranged to excite the inner set of features of target 102. As noted above, the set of outer features of target 102 may be the same or similar to the set of features 502 (shown in FIG. 5) or the set of features 602 (shown in FIG. 6). The set of inner features of target 102 may be the same or similar to one the set of features 504 (shown in FIG. 5) or the set of features 604 (shown in FIG. 6). In some implementations, transmitting coils 104A and 104B may be coupled in series. In some implementations, each of transmitting coils 104A, 104B, and receiving coils 106A-D, may be integrated in a different layer of the same multilayer printed circuit board (PCB). In such implementations, each of transmitting coils 104A and 104B, and each of receiving coils 106A-D may be implemented by using a different conductive trace or a different set of conductive traces. Additionally or alternatively, in some implementations, one or more of receiving coils 106A-D may be interweaved and situated in the same layer of a multilayer PCB. Additionally or alternatively, in some implementations, one or more of receiving coils 106A-D may be formed in the same layer of the PCB with at least one of transmitting coils 104A-B. (E.g., see the example of FIG. 8C.)

FIG. 5 shows an example of target 102, according to aspects of the disclosure. As illustrated, target 102 may include a band 503, a set of outer features 502 that are coupled to band 503, and a set of inner features 504 that are also coupled to the band 503. According to the present example, band 503 is shaped as a circular ring having a center C3. However, the present disclosure is not limited to any specific shape of band 503. For example, band 503 may be shaped as an ellipse or a rectangle, etc. Each of the features 502 and 504 may be shaped as the sector of a ring. However, the present disclosure is not limited to any specific shape for features 504 and 502.

According to the present example, each of features 502 has a width W1 and each of features 504 has a width W2, where W2<W1. According to the present example, the size (and/or surface area) of each of features 502 is greater than the size (and/or surface area) of any of features 504. Although, in the present example, features 502 all have the same size (and/or surface area), alternative implementations are possible in which at least one feature 502 has a smaller size (and/or surface area) than another one of the features 502. Although, in the present example, features 504 all have the same size (and/or surface area), alternative implementations are possible in which at least one feature 504 has a smaller size (and/or surface area) than another one of the features 504.

According to the present example, features 502 are separated by a distance D1 from one another, and they are evenly distributed along the entire outer perimeter of band 503. However, alternative implementations are possible in which at least three of the features 502 are spaced apart from one another by different distances. For example, a first feature 502 may be spaced from a second feature 502 by a first distance, and the second feature 502 may be spaced from a third feature 502 by a second distance that is different from the first distance, wherein the second feature 502 is situated between the first and third features 502, and wherein the first, second, and third features 502 are consecutive, such that no other features 502 are present between the first feature 502 and the second feature 502, as well as between the second feature 502 and the third feature 502. Furthermore, alternative implementations are possible in which all features 502 are concentrated in one portion of the perimeter of band 503 (e.g., in one-half of the perimeter).

According to the present example, features 504 are separated by a distance D2 from one another, and they are evenly distributed along the entire inner perimeter of band 503. However, alternative implementations are possible in which at least three of the features 504 are spaced apart from one another by different distances. For example, a first feature 504 may be spaced from a second feature 504 by a first distance, and the second feature 504 may be spaced from a third feature 504 by a second distance that is different from the first distance, wherein the second feature 504 is situated between the first and third features 504, and wherein the first, second, and third features 504 are consecutive, such that no other features 504 are present between the first feature 504 and the second feature 504, as well as between the second feature 504 and the third feature 504. Furthermore, alternative implementations are possible in which all features 504 are concentrated in one portion of the perimeter of band 503 (e.g., in one-half of the perimeter).

According to the present example, the set of inner features 504 includes fewer features than the set of outer features 502. However, alternative implementations are possible in which the set of features 504 includes a greater number of features than the set of features 502. Although in the present example, features 504 have a smaller width (and/or size) than features 502, alternative implementations are possible in which at least one of features 504 has a greater width (and/or size) than one or more features 502.

According to the example of FIG. 5, target 102 has an outer radius R3 and an inner radius R4. The outer radius R3 may be the distance from the center C3 to the outer edge of any of features 502. The inner radius R4 may be the distance from the center C3 to band 503. In some implementations, the outer radius R3 of target 102 may be substantially equal to the radius R1 of receiving coils 106A-B. Furthermore, in some implementations, the inner radius of target 102 may be substantially equal to the radius R2 of targets 106C-D. As used throughout the disclosure, the phrase “radius A is substantially equal to radius B” shall mean that the length of radius A is within +/−20% of the length of radius B.

In one example, target 102 may be formed of metal and/or any other electrically conductive material. Additionally or alternatively, in some implementations, target 102 may be formed by stamping a sheet of metal or other conductive material. In such implementations, features 502 and band 503 may be integral with each other, such that target 102 is a monolithic piece of metal (or a monolithic piece of another suitable material). Additionally or alternatively, in some implementations, target 102 may be used formed by using a lithographic technique to pattern the shape of target 102 out of a metal layer that is formed on a substrate. In such implementations, target 102 may be implemented as a printed circuit board (PCB) rather than a standalone conductive structure.

FIG. 6 shows an example of target 102, according to aspects of the disclosure. In the example of FIG. 6, target 102 includes a substrate 607, a set of outer features 602 that is disposed on substrate 607, and a set of inner features 604 that is formed on substrate 607. Unlike the implementation of FIG. 5, the implementation of target 102 which is shown in FIG. 6 does not include a band, such as the band 503 (shown in FIG. 5).

Each feature 602 may be centered on a shape 601 and each feature 604 may be centered on a shape 603. According to the present example, shapes 601 and 603 are concentric circles. However, in some implementations, shape 601 may be off-center from shape 603. Furthermore, alternative implementations are possible in which at least one of shapes 601 and 603 is a different type of shape, such as a rectangle or an ellipse, etc.

According to the present example, each of features 602 has a width W1 and each of features 604 has a width W2, where W2<W1. According to the present example, the size (and/or surface area) of each feature 602 is greater than the size (and/or surface area) of any of features 604. Although, in the present example, features 602 all have the same size (and/or surface area), alternative implementations are possible in which at least one feature 602 has a smaller size (and/or surface area) than another one of the features 602. Although, in the present example, features 604 all have the same size (and/or surface area), alternative implementations are possible in which at least one feature 604 has a smaller size (and/or surface area) than another one of the features 604.

According to the present example, features 602 are separated by a distance D1 from one another, and they are evenly distributed along the circumference of shape 601. However, alternative implementations are possible in which at least three of the features 602 are spaced apart from one another by different distances. For example, a first feature 602 may be spaced from a second feature 602 by a first distance, and the second feature 602 may be spaced from a third feature 602 by a second distance that is different from the first distance, wherein the second feature 602 is situated between the first and third features 602, and wherein the first, second, and third features 602 are consecutive, such that no other features 602 are present between the first feature 602 and the second feature 602, as well as between the second feature 602 and the third feature 602. Furthermore, alternative implementations are possible in which all features 602 are concentrated in one portion of the circumference of shape 601 (e.g., in one-half of the circumference).

According to the present example, features 604 are separated by a distance D2 from one another around the circumference of shape 603, and they are evenly distributed along the entire circumference of shape 603. However, alternative implementations are possible in which at least three of the features 604 are spaced apart from one another by different distances. For example, a first feature 604 may be spaced from a second feature 604 by a first distance, and the second feature 604 may be spaced from a third feature 604 by a second distance that is different from the first distance, wherein the second feature 604 is situated between the first and third features 604, and wherein the first, second, and third features 604 are consecutive, such that no other features 604 are present between the first feature 604 and the second feature 604, as well as between the second feature 604 and the third feature 604. Furthermore, alternative implementations are possible in which all features 604 are concentrated in one portion of the circumference of shape 603 (e.g., in one-half of the circumference).

According to the present example, the set of inner features 604 includes fewer features than the set of outer features 602. However, alternative implementations are possible in which the set of features 604 includes a greater number of features than the set of features 602. Although in the present example, features 604 have a smaller width (and/or size) than features 602, alternative implementations are possible in which at least one of features 604 has a greater width (and/or size) than one or more features 602.

According to the example of FIG. 6, target 102 has an outer radius R3 and an inner radius R4. The outer radius R3 may be the distance from the center C3 of shapes 601 and 603 to the outer edge of any of features 602. The inner radius R4 may be the distance from the center C3 of shapes 601 and 603 to the outer edge of any of features 604. In some implementations, the outer radius R3 may be substantially equal to the radius R1 of receiving coils 106A-B. Furthermore, in some implementations, the inner radius R4 may be substantially equal to the radius R2 of targets 106C-D.

Substrate 607 may be formed of any suitable type of insulating material, such as epoxy resin, polyethylene terephthalate (PET) plastic or fiberglass. In one example, features 602 and 604 may be formed by using any suitable type of lithographic technique. In such implementations, features 602 and 604 may be etched out of a solid layer of conductive material (e.g., metal) that is formed onto substrate 607. Additionally or alternatively, features 602 and 604 may be formed separately and mounted on substrate 607 by using glue or another adhesive. Stated succinctly, the present disclosure is not limited to any specific method for forming features 602 and 604.

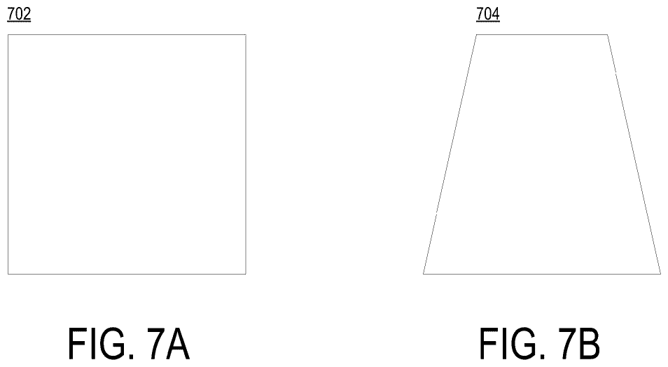

FIG. 7A shows an example of a conductive feature 702, which is shaped as a rectangle. Conductive feature 702 may be used to replace any of conductive features 502, 504, 602, and 604, which are discussed above with respect to FIGS. 5-6. FIG. 7A is provided to illustrate an example of another possible shape for conductive features 502. 504, 602, and 604.

FIG. 7B shows an example of a conductive feature 704, which is shaped as a trapezoid. Conductive feature 704 may be used to replace any of conductive features 502, 504, 602, and 604, which are discussed above with respect to FIGS. 5-6. FIG. 7B is provided to illustrate an example of another possible shape for conductive features 502. 504, 602, and 604. Stated succinctly, the present disclosure is not limited to any specific shape of features 502. 504, 602, and 604.

FIG. 8A is a schematic cross-sectional side view of an example of assembly 800 (shown in FIG. 1), according to aspects of the disclosure. In the example of FIG. 8A, assembly 800 includes the implementation of target 102 which is shown in FIG. 5. As illustrated, transmitting coils 104A-B and receiving coils 106A-D may be positioned over target 102 and separated from target 102 by an air gap 1004. Specifically, transmitting coil 104A and receiving coils 106A-B may be disposed over the set of outer features 502 of target 102, and transmitting coil 104B and receiving coils 106C-D may be disposed over the set of inner features 504 of target 102. In the present example, each of the transmitting coils 104A-B and receiving coils 106A-D is disposed above target 102. However, alternative implementations are possible in which transmitting coils 104A-B and receiving coils 106A-D are disposed below target 102. Although, in the present example, receiving coils 106A-D are disposed above transmitting coils 104A-B, it will be understood that the present disclosure is not limited to any specific relative positioning of transmitting coils 104A-B and receiving coils 106A-D along the Y-axis of coordinate system 202. Coordinate system 202 provides a common frame of reference for each of the illustrations shown in FIGS. 2-10.

In one aspect, each lobe 302 of receiving coils 106A and 106B may have a radial height H1, which is defined as the distance between the vertex of the lobe 302 and the line connecting the ends V1 and V2 of the lobe 302. (E.g., see FIG. 3A.) Each feature 502 of target 102 may have a radial height H3 which greater than or equal to the radial height H1. (E.g., see FIG. 5.) As a result of this arrangement, receiving coils 106A-B may be disposed exclusively above or below the features 502 of target 102.

In one aspect, each lobe 304 of receiving coils 106C and 106D may have a radial height H2, which is defined as the distance between the vertex of the lobe 304 and the line connecting the ends V3 and V4 of the lobe 304. (E.g., see FIG. 3B.) Each feature 504 of target 102 may have a radial height H4 which is greater than or equal to the radial height H2. (E.g., see FIG. 5.) As a result of this arrangement, receiving coils 106C-D may be disposed exclusively above or below the features 504 of target 102.

FIG. 8B is a schematic cross-sectional side view of another implementation of assembly 800 (shown in FIG. 1). In the example of FIG. 8B, assembly 800 includes the implementation of target 102 which is shown in FIG. 6. As illustrated, transmitting coils 104A-B and receiving coils 106A-D may be stacked over target 102. Specifically, transmitting coil 104A and receiving coils 106A-B may be disposed over the set of outer features 602 of target 102, and transmitting coil 104B and receiving coils 106C-D may be disposed over the set of inner features 604 of target 102. In the present example, each of the transmitting coils 104A-B and receiving coils 106A-D is disposed above target 102, and separated from target 102 by an air gap 1004. However, alternative implementations are possible in which transmitting coils 104A-B and receiving coils 106A-D are disposed below target 102. Although, in the present example, receiving coils 106A-D are disposed above transmitting coils 104A-B, it will be understood that the present disclosure is not limited to any specific relative positioning of transmitting coils 104A-B and receiving coils 106A-D along the Y-axis of coordinate system 202.

Although, in the example of FIGS. 8A-B, assembly 800 includes two transmitting coils (i.e., transmission coils 104A-B), alternative implementations are possible in which assembly 800 is provided with a single transmitting coil. In such implementations, the transmitting coil may be arranged to excite both the set of inner features 504/506 and the set of outer features 502/602.

FIG. 8C is a schematic cross-sectional side view of another implementation of assembly 800 (shown in FIG. 1). In the example of FIG. 8C, receiving coils 106A-D and transmitting coils 104A-B are disposed adjacent to each other, as shown, and separated from target 102 by an airgap 1004. In the example of FIG. 8C, receiving coils 106A-D and transmitting coils 104A-D may be formed in the same PCB layer and/or otherwise formed in the same plane. In some implementations, one or more of receiving coils 106A-D and transmitting coils 104A-D may be intertwined with each other.

FIG. 9A is a top-down view of the implementation of assembly 800 which is shown in FIG. 8A. According to the example of FIG. 9A, each of transmitting coils 104A-B and receiving coils 106A-D is centered on point C4, which may be situated directly above the center of target 102. However, it will be understood that alternative implementations are possible in which at least one of transmitting coils 104A-B and receiving coils 106A-D is off-center from point C4. Furthermore, it will be understood that alternative implementations are possible in which any two of transmitting coils 104A-B and receiving coils 106A-D are off-center from one another. In one aspect, FIG. 9A illustrates that receiving coil 106A may be the same or similar to receiving coil 106B and receiving coil 106C may be the same or similar to receiving coil 106D. In another aspect, FIG. 9A illustrates that receiving coil 106B may be rotated relative to receiving coil 106A and receiving coil 106D may be rotated relative to receiving coil 106C.

FIG. 9B is a top-down view of the implementation of assembly 800 which is shown in FIG. 8B. According to the example of FIG. 9B, each of transmitting coils 104A-B and receiving coils 106A-D is centered on point C4, which may be directly above the center of target 102. However, it will be understood that alternative implementations are possible in which at least one of transmitting coils 104A-B and receiving coils 106A-D is off-center from point C4. Furthermore, it will be understood that alternative implementations are possible in which any two of transmitting coils 104A-B and receiving coils 106A-D are off-center from one another. In one aspect, FIG. 9B illustrates that receiving coil 106A may be the same or similar to receiving coil 106B and receiving coil 106C may be the same or similar to receiving coil 106D. In another aspect, FIG. 9B illustrates that receiving coil 106B may be rotated relative to receiving coil 106A and receiving coil 106D may be rotated relative to receiving coil 106C.

FIG. 10 is a schematic diagram illustrating an example of one possible use of target 102. As illustrated, target 102 may be mounted on a rotating element 1002 (e.g., a shaft, etc.). Rotating element 1002 may be actuated by an electrical motor (not shown) and/or any other type of actuator. Rotating element 1002 may be arranged to rotate about an axis S-S. According to the present example, target 102 is centered on axis S-S and rotates with rotating element 1002. Transmitting coils 104A-B and receiving coils 106A-D may be spaced apart from target 102 by an air gap 1004. Transmitting coils 104A-D and receiving coils 106A-D may be coupled to sensor 108. Sensor 108 may drive transmitting coils 104A-B with signal 259, which is discussed above with respect to FIG. 2. Sensor 108 may receive, from receiving coils 106A-D, signals 107A-D, which are discussed above with respect to FIGS. 1-2.

Sensor 108 may use the Vernier principle to determine the angular position of target 102. The Vernier principle provides that each pair of electrical angles θ1 and θ2 of a target corresponds to a different angular position of the target. In the present example, sensor 108 may determine the electrical angles θ1 and θ2 of target 102, where θ1 is the electrical angle of the outer features 502/602 of target 102, and θ2 is the electrical angle of the inner features 504/604 of target 102. Afterward, sensor 108 may map the pair (θ1, θ2) to a corresponding value of the angular position of target 102. The mapping between the value of a pair (θ1, θ2) and its corresponding angular position may be performed by using a data structure (stored in the memory of sensor 108), which maps each of a plurality of values of the pair (θ1, θ2) to a corresponding angular position value.

Electrical angles θ1 and θ2 may be determined in accordance with equations 1 and 2 below:

$$θ 1 = arctan ( \frac{{val}_{107 A}}{v a {l}_{107 B}} ) \qquad ( 1 )$$

$$θ 2 = arctan ( \frac{{val}_{107 C}}{v a {l}_{107 D}} ) \qquad ( 2 )$$

Where val_{107A} is the value of signal 107A, val_{107B} is the value of signal 107B, val_{107C} is the value of signal 107C, and val_{107D} is the value of signal 107D. The application of the Vernier principle is discussed in further detail in U.S. patent application Ser. No. 17/809,382 entitled POSITION SENSING METHOD, which is hereby incorporated herein by reference in its entirety.

Alternatively, in some implementations, a look-up table can be used instead of performing calculations. The table may be stored in a built-in memory of sensor 108 (not shown). The table could have a plurality of entries (e.g., rows). Each entry may include a value of a first electrical angle, the value of a second electrical angle, and a mechanical angle value that corresponds to the pair of electrical angle values. The position of the target may be determined by performing a search of the table based on the electrical angle values. Irrespective of how the angular position of the target is implemented, it will be noted that using a target architecture such as the one shown in FIGS. 5 and 6 enables coverage of full mechanical revolution of the target, and a determination of the position of the target in the entire range of 0-360 degrees.

Throughout the disclosure, coil assemblies are provided that include multiple receiving and/or transmitting coils. In these assemblies, the receiving/transmitting coils are stacked. It will be understood that in any of the assemblies, the receiving/transmitting coils may be arranged in any order within the stack. Furthermore, it will be understood that one or more of the coils can be interweaved. When two coils are interweaved, a first portion of a first coil may be disposed above a second portion of a second coil and a third portion of the first coil may be disposed below a fourth portion of the second coil.

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., an addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A method, comprising:
providing a target including: (i) a base having a through-hole formed therein that defines an inner perimeter of the base, the base having an outer side running around an outer perimeter of the base, and the base having an inner side running around the inner perimeter of the base, (ii) a first set of first conductive features that are coupled to the outer side of the base, each of the first conductive features extending outwardly, (iii) and a second set of second conductive features that are coupled to the inner side of the base, each of the second conductive features extending inwardly, wherein a first count of the first conductive features in the first set is different from a second count of the second conductive features in the second set; and
detecting an angular position of the target based on a first electrical angle that is associated with the first set of first conductive features and a second electrical angle that is associated with the second set of second conductive features, wherein the angular position of the target is in the range 0-360 mechanical degrees so that the detected angular position covers an entire mechanical revolution of the target.

2. The method of claim 1, wherein any two adjacent first conductive features are spaced apart from one another by a first distance, and any two adjacent second conductive features are spaced apart from one another by a second distance that is different from the first distance.

3. The method of claim 1, wherein the first conductive features from the first set are evenly spread along an entire length of the outer side of the base and the second conductive features from the second set are spread along an entire length of the inner side of the base.

4. The method of claim 1, wherein at least one of the first conductive features has a different width than at least one of the second conductive features.

5. The method of claim 1, wherein the first conductive features are staggered with respect to the second conductive features.

6. The method of claim 1, wherein the base is shaped as a ring.

7. The method of claim 1, wherein each of the first conductive features is shaped as a sector of a ring and each of the second conductive features is shaped as a sector of a ring.

8. The method of claim 1, wherein each of the first conductive features is shaped as a rectangle or a trapezoid and each of the second conductive features is shaped as a rectangle or trapezoid.

9. The method of claim 1, wherein each of the first conductive features has a different size than any of the second conductive features.

10. The method of claim 1, wherein at least two of the first conductive features in the first set have different widths.

11. The method of claim 1, wherein each of the first conductive features in the first set has a same width.

12. The method of claim 1, wherein the outer side of the base defines a first shape and the inner side of the base define a second shape that is concentric with the first shape.

13. The method of claim 1, wherein the base, the first set of first conductive features, and the second set of second conductive features are integral with each other.

14. A target for use in inductive sensing applications, the target comprising:
a substrate;
a first set of first conductive features that are formed on the substrate, each of the first conductive features being aligned with a first loop; and
a second set of second conductive features that are formed on the substrate, each of the second conductive features being aligned with a second loop, the second loop being nested inside the first loop,
wherein a first count of the first conductive features in the first set is different from a second count of the second conductive features in the second set.

15. The target of claim 14, wherein any two adjacent first conductive features are spaced apart from one another by a first distance, and any two adjacent second conductive features are spaced apart from one another by a second distance that is different from the first distance.

16. The target of claim 14, wherein the first conductive features from the first set are evenly spread along an entire perimeter of the first loop and the second conductive features from the second set are spread along an entire perimeter of the second loop.

17. The target of claim 14, wherein at least one of the first conductive features has a different width than at least one of the second conductive features.

18. Target of claim 14, wherein the first conductive features are staggered with respect to the second conductive features.

19. The target of claim 14, wherein the first loop includes a first circle and the second loop includes a second circle, the second circle being concentric with the first circle.

20. The target of claim 14, wherein the first conductive features in the first set have a same size.

21. A system comprising:
a target including: (i) a base having a through-hole formed therein that defines an inner perimeter of the base, the base having an outer side running around an outer perimeter of the base, and the base having an inner side running around the inner perimeter of the base, (ii) a first set of first conductive features that are coupled to the outer side of the base, each of the first conductive features extending outwardly, and (iii) a second set of second conductive features that are coupled to the inner side of the base, each of the second conductive features extending inwardly, wherein a first count of the first conductive features in the first set is different from a second count of the second conductive features in the second set;
a first receiving coil configured to generate a first signal in response to a first reflected magnetic field that is produced by the first set of conductive features;
a second receiving coil configured to generate a second signal in response to the first reflected magnetic field that is produced by the first set of conductive features;
a third receiving coil configured to generate a third signal in response to a second reflected magnetic field that is produced by the second set of conductive features;
a fourth receiving coil configured to generate a fourth signal in response to the second reflected magnetic field that is produced by the first set of conductive features; and
a processing circuitry that is configured to generate an output signal based, at least in part, on the first signal, the second signal, the third signal, and the fourth signal, the output signal being indicative of an angular position of the target.

22. The system of claim 21, wherein any two adjacent first conductive features are spaced apart from one another by a first distance, and any two adjacent second conductive features are spaced apart from one another by a second distance that is different from the first distance.

23. The system of claim 21, wherein the first conductive features from the first set are evenly spread along an entire length of the outer side of the base and the second conductive features from the second set are spread along an entire length of the inner side of the base.

24. The system of claim 21, wherein at least one of the first conductive features has a different width than at least one of the second conductive features.

25. The system of claim 21, wherein the first conductive features are staggered with respect to the second conductive features.

26. The system of claim 21, wherein each of the first conductive features has a different size than any of the second conductive features.

27. The target of claim 21, wherein at least two of the first conductive features in the first set have different widths.
